(19) United States
(12) Patent Application Publication
(10) Pub. No.: US 2014/0289672 A1
(43) Pub. Date: Sep. 25, 2014

(54) GRAPH DISPLAY APPARATUS, GRAPH DISPLAY METHOD AND STORAGE MEDIUM HAVING STORED THEREON GRAPH DISPLAY PROGRAM

(71) Applicant: CASIO COMPUTER CO., LTD., Tokyo (JP)

(72) Inventor: Hiroshi UEJIMA, Tokyo (JP)

(73) Assignee: CASIO COMPUTER CO., LTD., Tokyo (JP)

(21) Appl. No.: 14/218,721

(22) Filed: Mar. 18, 2014

(30) Foreign Application Priority Data
Mar. 19, 2013 (JP) 2013-055832

(51) Int. Cl. G06F 3/0485; G06F 3/0488

(52) U.S. Cl. CPC G06F 3/0485; G06F 3/0488
USPC 715/784

(57) ABSTRACT

A graph display apparatus includes a display device, a graph display control unit, a scroll direction setting unit and a scroll control unit. The graph display control unit sets a coordinate system to a display area of the display device and displays a graph in the coordinate system. The scroll direction setting unit sets a scroll direction according to an operation performed by a user. The scroll control unit makes the displayed graph momentum-scroll in the scroll direction and stops the momentum-scrolling at a time when a characteristic part of at least one of the coordinate system and the graph reaches a center of the display area in at least one of an X-direction and a Y-direction.

### CROSS REFERENCE TO RELATED APPLICATION

This application is based upon and claims the benefit of priority under 35 USC 119 of Japanese Patent Application No. 2013-055832 filed on Mar. 19, 2013, the entire disclosure of which, including the description, claims, drawings and abstract, is incorporated herein by reference in its entirety.

### BACKGROUND OF THE INVENTION

1. Field of the Invention

The present invention relates to a graph display apparatus, a graph display method and a storage medium having stored thereon a graph display program.

2. Description of the Related Art

A conventional information display apparatus, which displays information such as images and texts, scrolls the display content with momentum (inertia) according to a user operation.

By the way, when the display content is momentum-scrolled, the amount of the momentum-scrolling may be larger or smaller than the amount thereof which a user intends to make.

Hence, a recent information display apparatus, which displays information such as images and texts and momentum-scrolls the display content, detects a certain image from images which could be displayed by the momentum-scrolling and stops the momentum-scrolling at a time when the detected image is displayed at a predetermined position, which is described, for example, in Japanese Patent Application Laid-Open Publication No. 2008-77183 (Patent Document 1).

Further, an information display apparatus, which displays headwords of a dictionary database in a list form in order of prefix-matching an input character string and scrolls the display content, temporarily slows down the scroll speed at a time when a letter immediately after the input character string is switched to another, which is described, for example, in Japanese Patent Application Laid-Open Publication No. 2007-94987 (Patent Document 2). More specifically, with the art described in Patent Document 2, for example, when a character string “bea” is input, headwords which prefix-match the input character string are displayed in a list form, and when the display content is scrolled, headwords “beach”, “beacon”, . . . (headwords having “c” immediately after the input character string “bea”) are displayed, and then the scroll speed temporarily decreases at a time when a headword “head” (a headword having “d” immediately after the input character string “bea”) is displayed.

### BRIEF SUMMARY OF THE INVENTION

However, these arts are made without giving consideration to characteristics included in graphs or coordinate systems. Therefore, in the case where the display content in a coordinate system, such as a graph (s) based on a mathematical formula, is momentum-scrolled, the momentum-scrolling cannot be stopped at a proper position.

Objects of the present invention include providing a graph display apparatus, a graph display method and a storage medium having stored thereon a graph display program each of which can reduce user's troublesomeness in momentum-scrolling a graph displayed in a coordinate system.

In order to achieve at least one of the objects, according to an aspect of the present invention, there is provided a graph display apparatus including: a display device; a graph display control unit which sets a coordinate system to a display area of the display device and displays a graph in the coordinate system; a scroll direction setting unit which sets a scroll direction according to an operation performed by a user; and a scroll control unit which makes the displayed graph momentum-scroll in the scroll direction and stops the momentum-scrolling at a time when a characteristic part of at least one of the coordinate system and the graph reaches a center of the display area in at least one of an X-direction and a Y-direction.

### BRIEF DESCRIPTION OF THE DRAWINGS

The present invention will be more fully understood from the detailed description given hereinafter and the appended drawings, which are given by way of illustration only, and thus are not intended as a definition of the limits of the present invention, wherein:

FIG. 1 is a block diagram showing the functional configuration of a graph display apparatus;

FIG. 2 is a flowchart of a graph display process;

FIG. 3 is a flowchart of a drag process;

FIG. 4 is a flowchart of a swipe process;

FIG. 5 is a flowchart of an enlargement/reduction process;

FIGS. 6A to 6C each show display content on a display;

FIG. 7A shows an XY plane;

FIGS. 7B to 7D each show the display content on the display;

FIG. 8 is a flowchart of a swipe process;

FIGS. 9A to 9C each show the display content on the display; and

FIGS. 10A and 10B each show the display content on the display.

### DETAILED DESCRIPTION OF THE INVENTION

In the following, an embodiment of the present invention is described in detail with reference to the attached drawings. However, the scope of the present invention is not limited thereto.

### [Configuration]

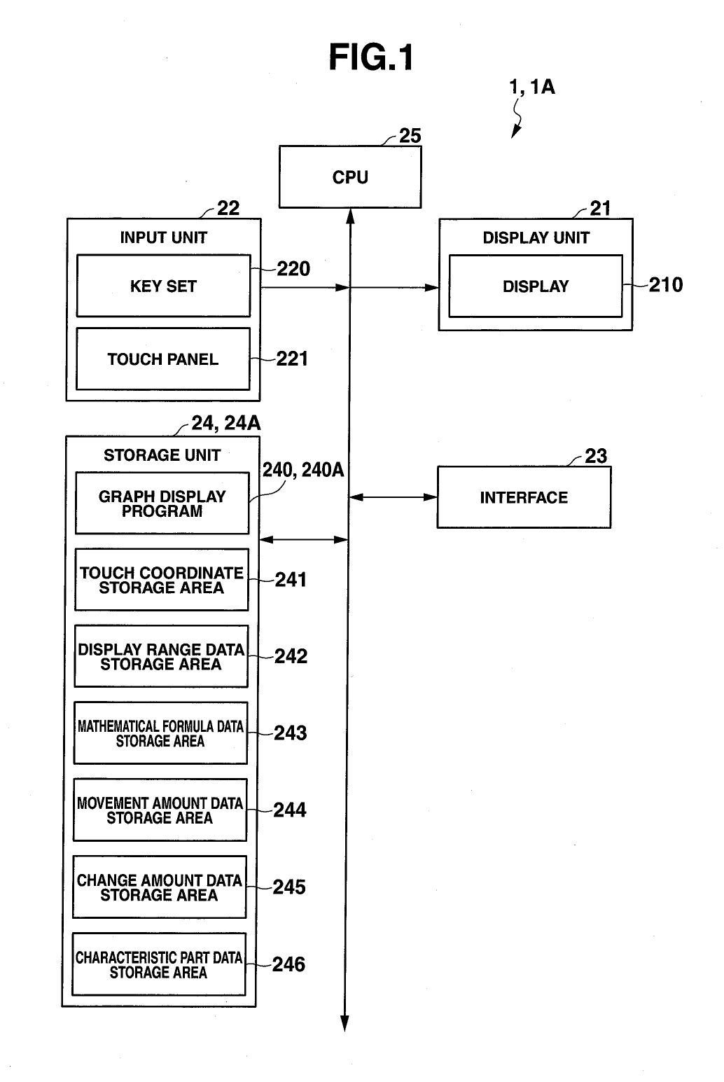

FIG. 1 is a block diagram showing the functional configuration of a graph display apparatus 1 according to the embodiment.

As shown in FIG. 1, the graph display apparatus 1 includes a display unit 21, an input unit 22, an interface 23, a storage unit 24 and a CPU 25.

The display unit 21 includes a display 210, and various pieces of information are displayed on the display 210 in response to display signals input from the CPU 25. The display 210 of the embodiment is integrally formed with a touch panel 221 and can receive touch operations performed by a user.

The input unit 22 includes a key set 220 and the touch panel 221 and outputs signals corresponding to types of pressed keys or touch points on the touch panel 221 to the CPU 25.

The interface 23 is a connection terminal to connect to a not-shown external apparatus. In the embodiment, the interface 23 reads mathematical formula data and the like from the external apparatus via a USB cable, so that the data can be stored in the storage unit 24.

The storage unit 24 is a memory which stores therein programs and data to realize various functions of the graph display apparatus 1 and functions as a work area for the CPU 25. In the embodiment, the storage unit 24 stores therein a graph display program 240 and the like of the present invention and has a touch coordinate storage area 241, a display range data storage area 242, a mathematical formula data storage area 243, a movement amount data storage area 244, a change amount data storage area 245, a characteristic part data storage area 246 and the like.

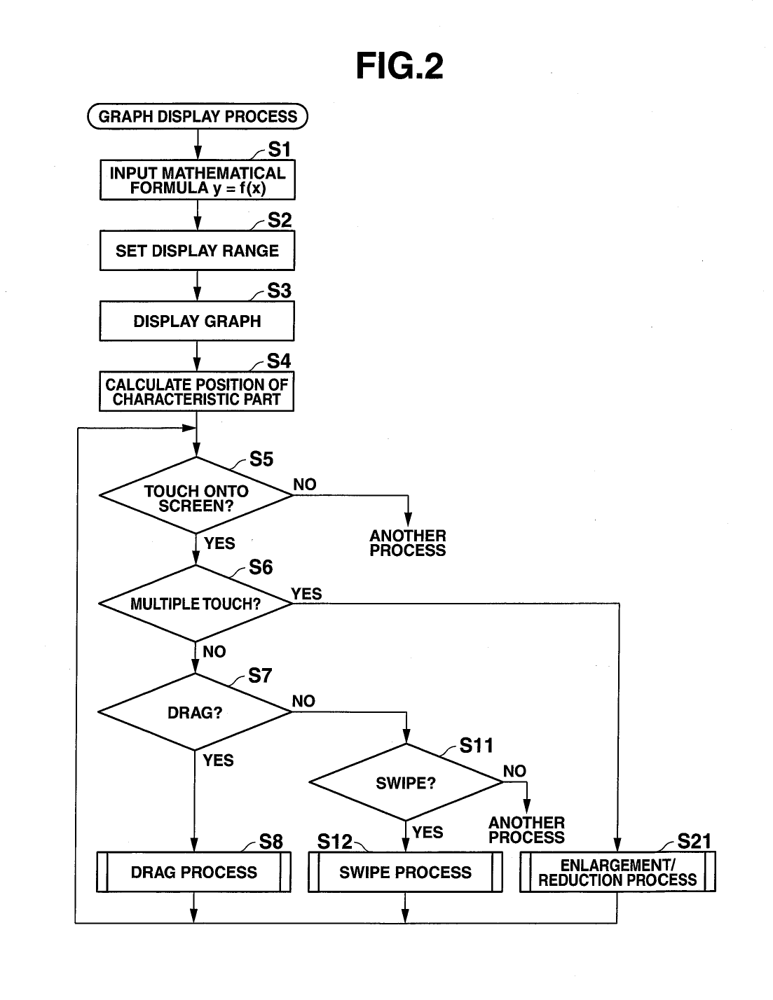

The graph display program 240 is a program for the CPU 25 to perform a graph display process (FIG. 2) described below.

The touch coordinate storage area 241 stores therein coordinates of touch points (positional information in a display area) at which a user performs touch operations in the graph display process.

The display range data storage area 242 stores therein a display range (Xmin, Xmax, Ymin, Ymax) of an XY coordinate system set to the display area of the display 210 in the graph display process.

The mathematical formula data storage area 243 stores therein mathematical formula data of functions input by a user in the graph display process.

The movement amount data storage area 244 stores therein a total movement amount (dX, dY) or the like used to scroll (move) the content displayed within the display range (Xmin, Xmax, Ymin, Ymax) of the coordinate system in the graph display process.

The change amount data storage area 245 stores therein a change amount per unit time (ΔX, ΔY) or the like used to scroll the content displayed within the display range (Xmin, Xmax, Ymin, Ymax) of the coordinate system in the graph display process.

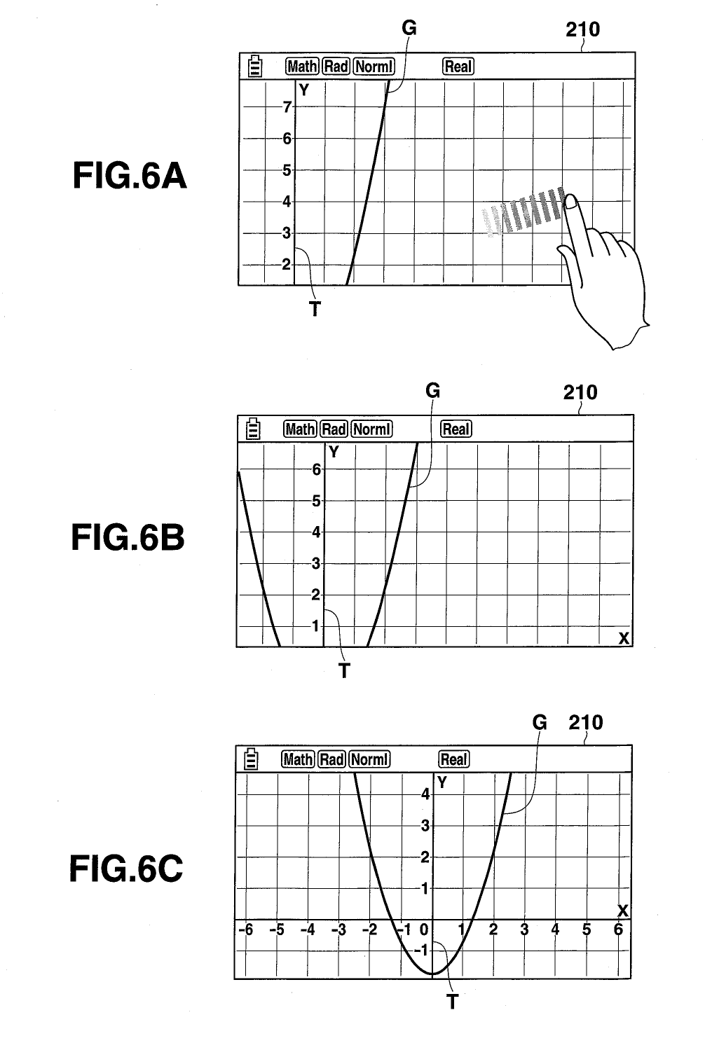

The characteristic part data storage area 246 stores therein positional information (positional information in the coordinate system and positional information in the display area) about characteristic parts T (FIGS. 6A to 6C) of the coordinate system and a graph (s) G displayed in the coordinate system in the graph display process. In the embodiment, as the characteristic parts T of the coordinate system and the graph G, coordinate axes and characteristic points (for example, an inflection point) of the graph G are used.

The CPU 25 performs centralized-control on the components of the graph display apparatus 1. More specifically, the CPU 25 executes a system program stored in the storage unit 24 and a program (s) specified from various application programs stored in the storage unit 24, whereby various types of action of the graph display apparatus 1 can be performed.

### [Action]

Next, the graph display process performed by the graph display apparatus 1 is described with reference to the drawings.

FIG. 2 is a flowchart to explain actions of the graph display process. The graph display process is performed by the CPU 25 and the graph display program 240 working together. More specifically, when a user inputs a command to execute the graph display process through the input unit 22, the CPU 25 reads the graph display program 240 from the storage unit 24 and loads the read graph display program 240 into a RAM (not shown) so as to perform the graph display process.

In the graph display process, first, the CPU 25 inputs a function (y=f(x)) of variables x and y according to a user operation and stores the function in the mathematical formula data storage area 243 (Step S1).

Next, the CPU 25 sets a display range (Xmin, Xmax, Ymin, Ymax) of an XY coordinate system to the display area of the display 210 according to a user operation and stores the display range in the display range data storage area 242 (Step S2). The CPU 25 may read the content of a display range previously set and set the read display range to the display area. The CPU 25 may set scale intervals of the coordinate axes in addition to the display range of the coordinate system.

Next, the CPU 25 displays (draws) a graph G of the function (mathematical formula) input at Step S1, or a graph G of the function input at Step S1 within the display range set at Step S2 to be more specific, on the display 210 (Step S3). In the embodiment, in order to generate the graph G, the CPU 25 changes X values from Xmin to Xmax of the display range in such a way as to correspond to pixels of the display 210 within the display range one-to-one, substitutes the X values into the function (y=f(x)) in order so as to calculate Y values, and plots the (X, Y) coordinate points to draw the graph Gin the display area. If the coordinate axes exist inside the display range, the coordinate axes are also drawn. Hereinafter, the “display content” regarding graphs includes graphs G of functions and coordinate axes.

Next, the CPU 25 calculates characteristic parts T of the coordinate system and the graph G and temporarily stores positional information (positional information in the coordinate system and positional information in the display area) about the characteristic parts T in the characteristic part data storage area 246 (Step S4).

Next, the CPU 25 determines whether or not a user touches the display 210 (Step S5). When determining that no user touches the display 210 (Step S5; NO), the CPU 25 moves to another process.

On the other hand, when determining that a user touches the display 210 (Step S5; YES), the CPU 25 stores coordinates of the touch point(s) (positional information in the display area) in the touch coordinate storage area 241 and determines whether or not the user touches multiple points on the display 210, namely, whether or not multiple touch is performed (Step S6).

The CPU 21 determines that multiple touch is not performed (Step S6; NO) when the user touches the display 210 with one finger or a pen. Then, the CPU 21 determines whether or not a drag operation is performed by the touch (Step S7). The “drag” is an action to slowly move a finger or a pen sideways on a screen.

When determining that a drag operation is performed by the touch (Step S7; YES), the CPU 25 performs a drag process to scroll the display content following the movement of the finger or pen (Step S8).

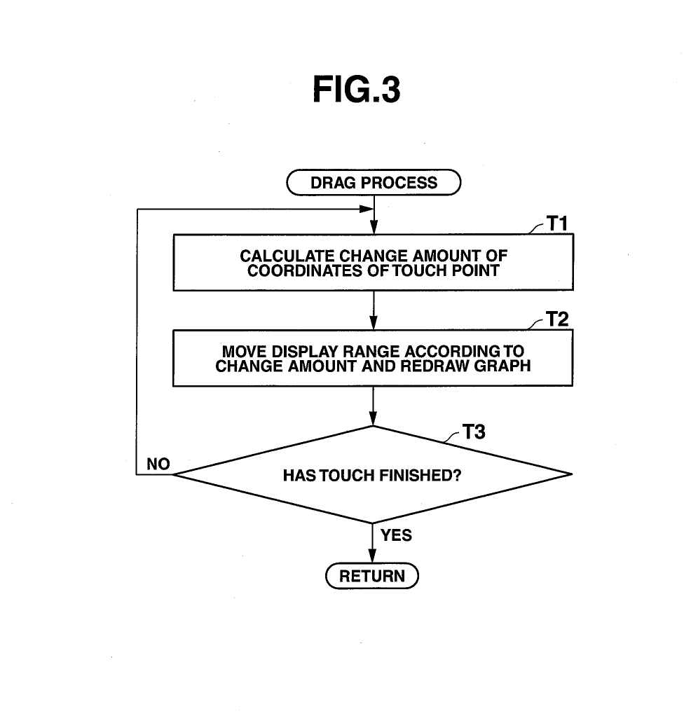

The drag process is described in detail with reference to FIG. 3. In the drag process, first, the CPU 25 refers to the touch coordinate storage area 241 and calculates a change amount of coordinates of the touch point made by the drag operation (Step T1).

Next, the CPU 25 changes the display range of the coordinate system according to the calculated change amount, stores the changed display range in the display range data storage area 242, sets the changed display range to the display 210 (resets the display range), calculates values of the function within the reset display range, and redraws the graph G of the function in the display area (Step T2). Thus, in response to the drag operation, the display range of the coordinate system changes, and the display content scrolls.

Next, the CPU 25 determines whether or not the touch onto the display 210 has finished (Step T3). When determining that the touch onto the display 210 has not finished yet (Step T3; NO), the CPU 25 returns to Step T1 to repeat the process to scroll the display content following the movement of the touch point.

On the other hand, when determining that the drag operation has finished and the touch onto the display 210 has finished (Step T3; YES), the CPU 25 returns to Step S5 shown in FIG. 2.

When determining at Step S7 that a drag operation is not performed by the touch (Step S7; NO), the CPU 25 determines whether or not a swipe operation is performed by the touch (Step S11). The “swipe” is an action to quickly move a finger or a pen sideways on a screen.

When determining that a swipe operation is not performed by the touch (Step S11; NO), the CPU 25 moves to another process. On the other hand, when determining that a swipe operation is performed by the touch (Step S11; YES), the CPU 25 performs a swipe process (Step S12).

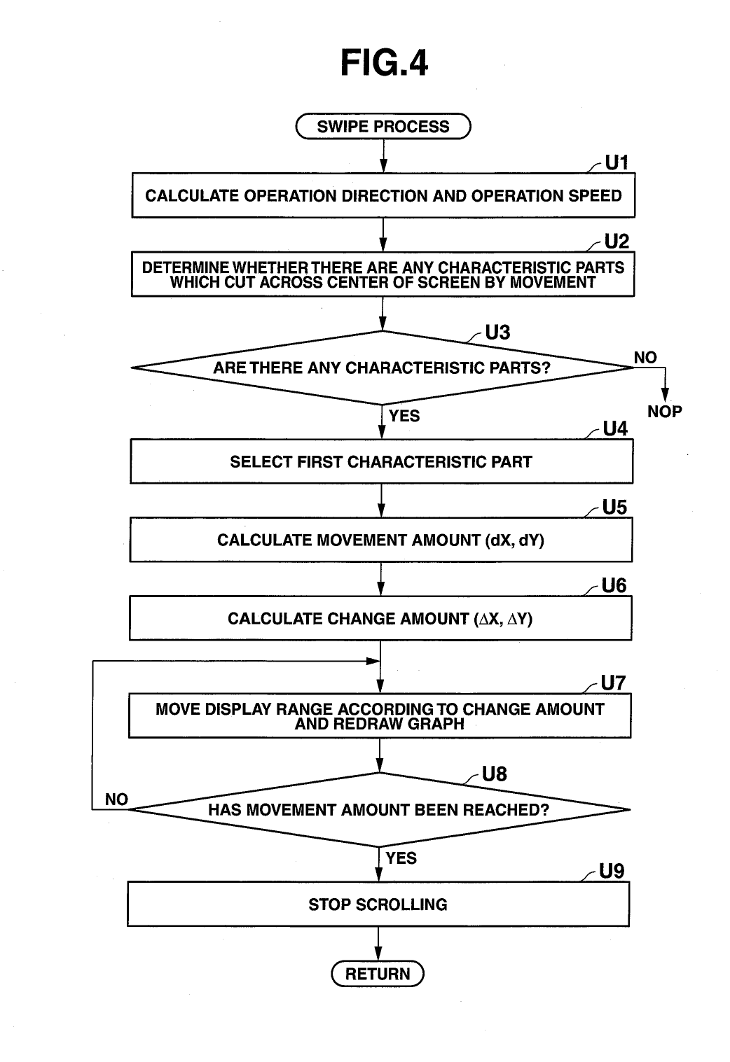

The swipe process is described in detail with reference to FIG. 4. In the swipe process, first, the CPU 25 calculates the direction of the swipe operation (hereinafter, a scroll direction) and the speed of the swipe operation (hereinafter, a swipe speed) (Step U1).

Next, the CPU 25 reads the positional information about the characteristic parts T of the coordinate system and the graph G from the characteristic part data storage area 246 and determines whether or not there are any characteristic parts T which cut across the center of the display area when the momentum-scrolling is performed in the scroll direction (Step U2). The center of the display area is the center of the display area in the X direction and/or the Y direction. It is unnecessary that the center of the display area is the exact center of the display area in the X direction and/or the Y direction. The center thereof is determined with some tolerance according to the display content and/or the state of the graph display apparatus 1.

When determining that there are no characteristic parts T which cut across the center of the display area (Step U3; NO), the CPU 25 performs no process (NOP).

On the other hand, when determining that there is at least one characteristic part T which cuts across the center of the display area (Step U3; YES), the CPU 25 selects, from among the at least one characteristic part T, a characteristic part T which cuts across the center of the display area first (Step U4), and calculates the total movement amount (dX, dY) used to scroll the display content so that the selected characteristic part T reaches the center of the display area and stores the calculated total movement amount (dX, dY) in the movement amount data storage area 244 (Step U5).

Next, the CPU 25 calculates the change amount (ΔX, ΔY) of the display range (Xmin, Xmax, Ymin, Ymax) per unit time from the calculated total movement amount (dX, dY) and the swipe speed and stores the calculated change amount (ΔX, ΔY) in the change amount data storage area 245 (Step U6).

Next, the CPU 25 changes the display range of the coordinate system according to the calculated change amount (ΔX, ΔY), stores the changed display range in the display range data storage area 242, sets the changed display range to the display 210 (resets the display range), calculates values of the function within the reset display range, and redraws the graph G of the function in the display area (Step U7). By executing the contents of this step at unit time intervals, in response to the swipe operation, the display content momentum-scrolls in the scroll direction.

Next, the CPU 25 determines whether or not the display content has momentum-scrolled by the total movement amount (dX, dY) stored in the movement amount data storage area 244 (Step U8). When determining that the display content has not momentum-scrolled by the total movement amount (dX, dY) yet (Step U8; NO), the CPU 25 returns to Step U7. When returning to Step U7, the CPU 25 may slow down the scroll speed by one level so as to gradually decrease the scroll speed over time.

On the other hand, when determining that the display content has momentum-scrolled by the total movement amount (dX, dY) (Step U8; YES), the CPU 25 stops the momentum-scrolling (Step U9). Thus, in the case of the momentum-scrolling, the momentum-scrolling stops at a time when the characteristic part T reaches the center of the display area.

When determining at Step S6 that multiple touch is performed (Step S6; YES), the CPU 25 performs an enlargement/reduction process (Step S21).

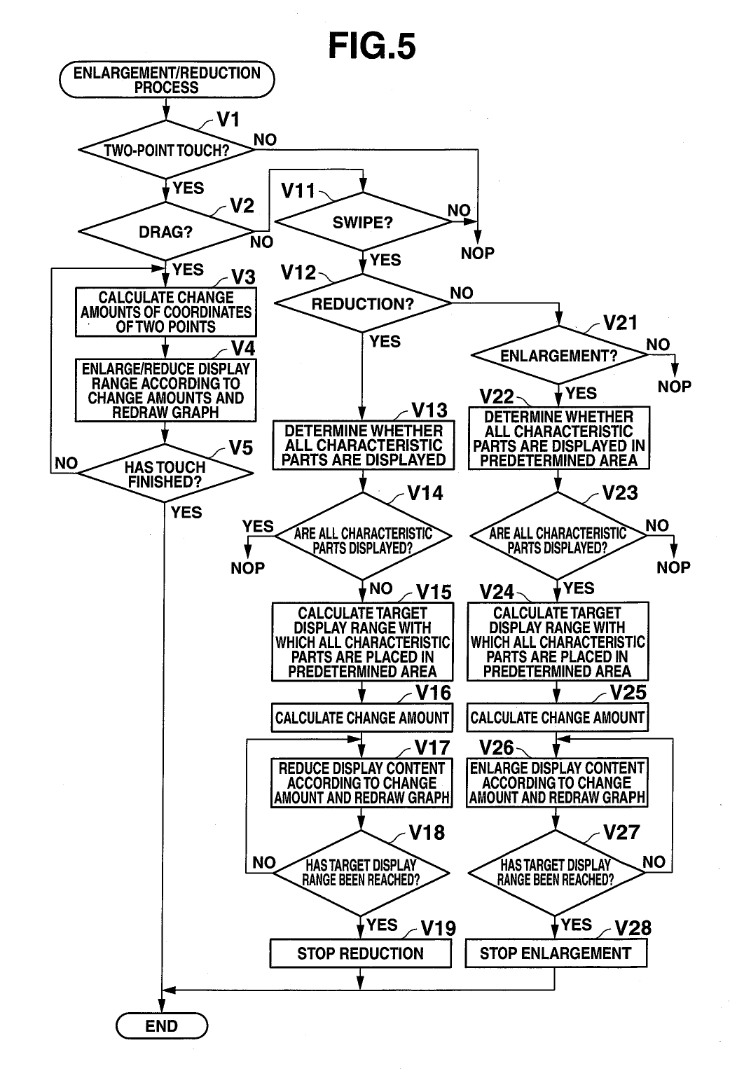

The enlargement/reduction process is described in detail with reference to FIG. 5. In the enlargement/reduction process, first, the CPU 25 determines whether or not the multiple touch is two-point touch (Step V1). When determining that the multiple touch is not two-point touch but three- or more-point touch (Step V1; NO), the CPU 25 performs no process (NOP).

On the other hand, when determining that the multiple touch is two-point touch (Step V1; YES), the CPU 25 determines whether or not a drag operation for pinch-out/pinch-in is performed by the two-point touch (Step V2).

When determining that a drag operation for pinch-out/pinch-in is performed by the two-point touch (Step V2; YES), the CPU 25 refers to the touch coordinate storage area 241 and calculates the change amounts of coordinates of the two touch points made by the drag operation (Step V3).

Next, the CPU 25 changes the display range of the coordinate system according to the calculated change amounts, stores the changed display range in the display range data storage area 242, sets the changed display range to the display 210 (resets the display range), calculates values of the function within the reset display range, and redraws the graph G of the function in the display area (Step V4). Thus, in response to the drag operation, the display content enlarges/reduces.

Next, the CPU 25 determines whether or not the touch onto the display 210 has finished (Step V5). When determining that the touch onto the display 210 has not finished yet (Step V5; NO), the CPU 25 returns to Step V3.

On the other hand, when determining that the touch onto the display 210 has finished (Step V5; YES), the CPU 25 ends the enlargement/reduction process and returns to Step S5 shown in FIG. 2.

When determining at Step V2 that a drag operation for pinch-out/pinch-in is not performed by the two-point touch (Step V2; NO), the CPU 25 determines whether or not a swipe operation is performed by the two-point touch (Step V11).

When determining that a swipe operation is not performed by the two-point touch (Step V11; NO), for example, when recognizing that two points on the display 210 is touched but not recognizing any movement, the CPU 25 performs no process (NOP).

On the other hand, when determining that a swipe operation is performed by the two-point touch (Step V11; YES), the CPU 25 determines whether or not the swipe operation is for pinch-in (reduction) (Step V12).

When determining that the swipe operation is for pinch-in (Step V12; YES), the CPU 25 determines whether or not all the characteristic parts T exist inside the current display range (Xmin, Xmax, Ymin, Ymax) of the coordinate system (Step V13).

When determining that all the characteristic parts T exist inside the current display range (Step V14; YES), the CPU 25 does not do anything about the swipe operation (NOP).

On the other hand, when determining that not all the characteristic parts T exist inside the current display range (Step V14; NO), the CPU 25 calculates a display range (Xmin, Xmax, Ymin, Ymax) which is larger than the current display range and with which all the characteristic parts T are placed in a predetermined area inside the peripheral edge of the display area as a target display range (Step V15).

Next, the CPU 25 calculates the swipe speed, calculates the change amount of the display range per unit time from the swipe speed, the current display range and the target display range and stores the calculated change amount in the change amount data storage area 245 (Step V16).

Next, the CPU 25 changes the display range of the coordinate system according to the calculated change amount, stores the changed display range in the display range data storage area 242, sets the changed display range to the display 210 (resets the display range), calculates values of the function within the reset display range, and redraws the graph G of the function in the display area (Step V17). Thus, in response to the swipe operation, the display range of the coordinate system automatically and continuously enlarges, and the display content reduces with inertia.

Next, the CPU 25 determines whether or not the current display range matches the target display range, namely, whether or not the display range has been enlarged (the display content has been reduced) to the target display range (Step V18). When determining that the current display range does not match the target display range (Step V18; NO), the CPU 25 returns to Step V17.

On the other hand, when determining that the current display range matches the target display range (Step V18; YES), the CPU 25 stops the reduction of the display content in the coordinate system (Step V19) and ends the enlargement/reduction process.

When determining at Step V12 that the swipe operation is not for pinch-in (reduction) (Step V12; NO), the CPU 25 determines whether or not the swipe operation is for pinch-out (enlargement) (Step V21).

When determining that the swipe operation is not for pinch-out (Step V21; NO), the CPU 25 does not do anything about the swipe operation (NOP).

On the other hand, when determining that the swipe operation is for pinch-out (Step V21; YES), the CPU 25 determines whether or not all the characteristic parts T are placed in a predetermined area inside the peripheral edge of the display area (Step V22). This predetermined area is arranged at the center of a display screen of the display 210 and has a display size of about a half of the display size of the whole display area, for example.

When determining that not all the characteristic parts T are placed in the predetermined area (Step V23; NO), the CPU 25 does not do anything about the swipe operation (NOP).

On the other hand, when determining that all the characteristic parts T are placed in the predetermined area (Step V23; YES), the CPU 25 calculates a display range (Xmin, Xmax, Ymin, Ymax) with which all the characteristic parts T are placed in the predetermined area inside the peripheral edge of the display area as a target display range (Step V24).

Next, the CPU 25 calculates the swipe speed, calculates the change amount of the display range per unit time from the swipe speed, the current display range and the target display range and stores the calculated change amount in the change amount data storage area 245 (Step V25).

Next, the CPU 25 changes the display range of the coordinate system according to the calculated change amount, stores the changed display range in the display range data storage area 242, sets the changed display range to the display 210 (resets the display range), calculates values of the function within the reset display range, and redraws the graph G of the function in the display area (Step V26). Thus, in response to the swipe operation, the display range of the coordinate system automatically and continuously reduces, and the display content enlarges with inertia.

Next, the CPU 25 determines whether or not the current display range matches the target display range, namely, whether or not the display range has been reduced (the display content has been enlarged) to the target display range (Step V27). When determining that the current display range does not match the target display range (Step V27; NO), the CPU 25 returns to Step V26.

On the other hand, when determining that the current display range matches the target display range (Step V27; YES), the CPU 25 stops the enlargement of the display content in the coordinate system (Step V28) and ends the enlargement/reduction process.

### Action Examples

Next, the action of the graph display apparatus 1 is described in detail with reference to the drawings.

### First Action Example

First, a user inputs a function “y=x²−2” (Step S1) and sets a display range of an XY coordinate system, “Xmin=−1, Xmax=11, Ymin=2, Ymax=8”, to the display area of the display 210 (Step S2). Then, as shown in FIG. 6A, a graph G of the function “y=x²−2” within the display range is displayed (drawn) on the display 210 (Step S3).

Next, when the user performs a swipe operation in the slightly-upper-right direction (Step S11; YES), the slightly-upper-right direction is calculated as the scroll direction, and the swipe speed is calculated (Step U1).

Next, it is determined that there is at least one characteristic part T which cuts across the center of the display area when the momentum-scrolling is performed in the scroll direction (Step U3; YES), and a characteristic part T (Y axis in this example) which cuts across the center of the display area first is selected from among the at least one characteristic part T (Step U4).

Next, the total movement amount (dX, dY) used to scroll the display content in the coordinate system so that the selected characteristic part T (Y axis) reaches the center of the display area is calculated (Step U5), and also the change amount (ΔX, ΔY) of the display range per unit time is calculated (Step U6).

Next, as shown in FIG. 6B, the display range is reset according to the calculated change amount (ΔX, ΔY), values of the function within the reset display range are calculated, and the graph G of the function is redrawn in the display area (Step U7). By executing the contents of this step at unit time intervals, the display content momentum-scrolls in the scroll direction.

When it is determined that the display content has momentum-scrolled by the total movement amount (dX, dY) (Step U8; YES), as shown in FIG. 6C, the momentum-scrolling stops (Step U9). Thus, the momentum-scrolling stops at a time when the characteristic part T (Y axis) reaches the center of the display area.

### Second Action Example

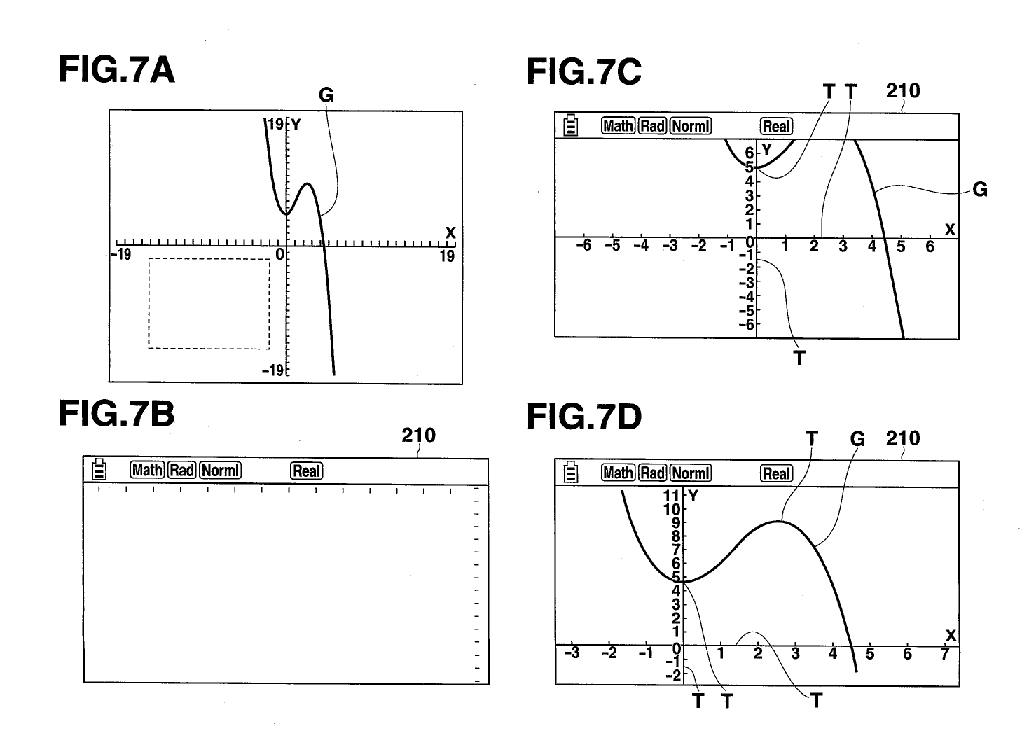

For example, a user inputs a function “y=−0.5x³+2x²+5” (Step S1) and sets a display range of an XY coordinate system, “Xmin=−16, Xmax=−2, Ymin=−16, Ymax=−2”, to the display area of the display 210 (Step S2). In this case, a relationship between a graph and a display range is as shown in FIG. 7A. The range indicated by a broken-line frame is the display range.

Although the CPU 25 attempts to display a graph G of the function “y=−0.5x³+2x²+5” within the display range “Xmin=−16, Xmax=−2, Ymin=−16, Ymax=−2” on the display 210, the graph G within the display range does not exist. Therefore, as shown in FIG. 7B, no graph G is displayed on the display 210. Neither the X axis nor the Y axis exists inside the display range. Then, coordinate gradations are displayed on edge parts on sides in the display area of the display 210, the sides where the X axis and the Y axis exist, respectively.

Next, when the user performs a swipe operation in the lower-left direction (Step S11; YES), the lower-left direction is calculated as the scroll direction, and the swipe speed is calculated (Step U1).

Next, it is determined that there is at least one characteristic part T which cuts across the center of the display area when the momentum-scrolling is performed in the scroll direction (Step U3; YES), and a characteristic part T (Y axis in this example) which cuts across the center of the display area first is selected from among the at least one characteristic part T (Step U4).

Next, the total movement amount (dX, dY) used to scroll the display content in the coordinate system so that the selected characteristic part T (Y axis) reaches the center of the display area is calculated (Step U5), and also the change amount (ΔX, ΔY) of the display range per unit time is calculated (Step U6).

Next, the display range of the coordinate system is changed (reset) according to the calculated change amount (ΔX, ΔY), values of the function “y=−0.5x³+2x²+5” within the reset display range are calculated, and the graph G of the function is drawn in the display area (Step U7). By executing the contents of this step at unit time intervals, the display content (blank display content with coordinate gradations in this example) in the coordinate system momentum-scrolls in the scroll direction.

When it is determined that the display content has momentum-scrolled by the total movement amount (dX, dY) (Step U8; YES), as shown in FIG. 7C, the momentum-scrolling stops (Step U9). Thus, the momentum-scrolling stops at a time when the characteristic part T (Y axis) reaches the center of the display area.

Next, when the user performs a swipe operation for pinch-in (Step V12; YES), it is determined that not all the characteristic parts T exist inside the current display range (Xmin=−7, Xmax=7, Ymin=−7, Ymax=7) of the coordinate system (Step V14; NO), and a display range (Xmin=−3, Xmax=7, Ymin=−3, Ymax=11) which is larger than the current display range and with which all the characteristic parts T are placed in a predetermined area inside the peripheral edge of the display area is calculated as a target display range (Step V15).

Next, the swipe speed and the change amount of the display range per unit time are calculated (Step V16), and the display range of the coordinate system is reset according to the calculated change amount, values of the function “y=−0.5x³+2x²+5” within the reset display range are calculated, and the graph G of the function is redrawn in the display area (Step V17) as shown in FIG. 7D. By executing the contents of this step at unit time intervals, the display range of the coordinate system automatically and continuously enlarges, and the display content reduces with inertia.

When it is determined that the current display range matches the target display range, namely, the display range has been enlarged (the display content has been reduced) to the target display range (Step V18; YES), the reduction of the display content stops (Step V19). Thus, the reduction stops at a time when all the characteristic parts T are displayed.

As described above, according to the embodiment, as shown in FIGS. 4, 6A to 6C, 7A to 7D and the like, the display content in the coordinate system is momentum-scrolled in the scroll direction according to a user operation, and the momentum-scrolling is stopped at a time when a characteristic part T of the coordinate system and/or the graph G reaches the center of the display area. Hence, in the case where the display content in the coordinate system is momentum-scrolled, the momentum-scrolling can be stopped at a proper position. Therefore, as compared with the conventional arts, user's troublesomeness in momentum-scrolling the display content in the coordinate system can be reduced.

### [Modification]

Next, a modification of the graph display apparatus 1 of the embodiment is described. The components which are the same as those of the embodiment are denoted by the same reference symbols, and description thereof is omitted.

### [Configuration]

As shown in FIG. 1, a graph display apparatus 1A according to the modification includes a storage unit 24A. The storage unit 24A stores a graph display program 240A of the present invention therein.

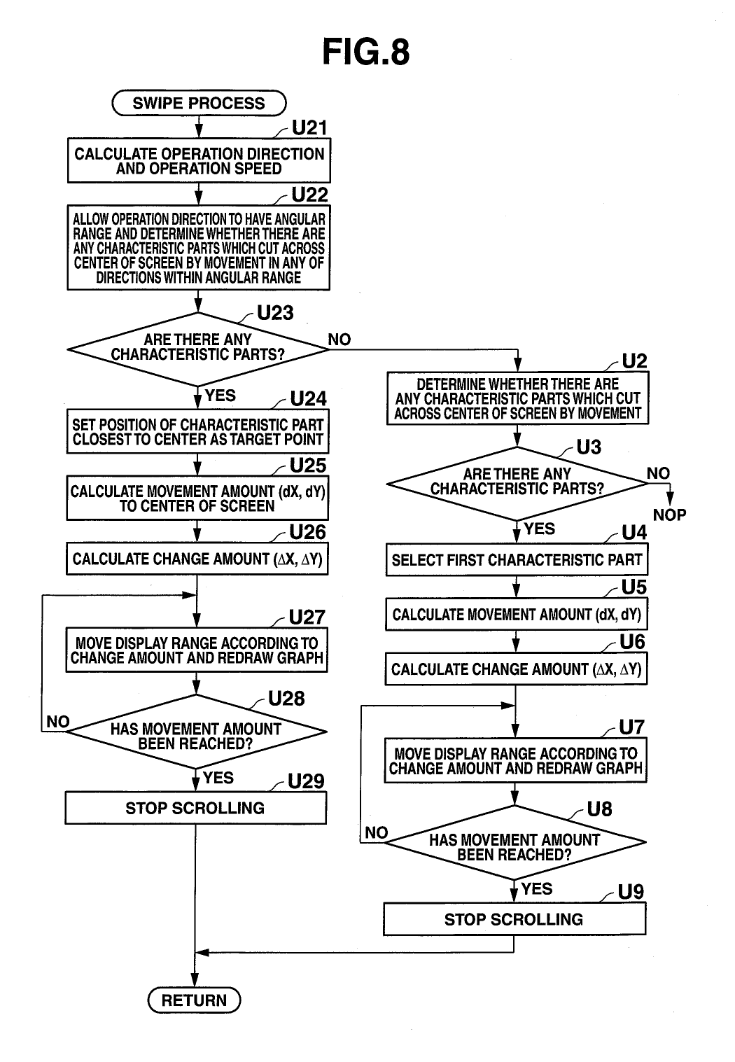

The graph display program 240A is a program for the CPU 25 to perform a graph display process which is the same as that shown in FIG. 2 except that, at Step S12 in the graph display process, the CPU 25 performs a swipe process shown in FIG. 8 described below instead of the swipe process shown in FIG. 4.

### [Action]

Next, the swipe process performed by the graph display apparatus 1A is described with reference to the drawings.

FIG. 8 is a flowchart to explain actions of the swipe process.

As shown in FIG. 8, in the swipe process of the modification, first, the CPU 25 calculates the direction of the swipe operation (hereinafter, a scroll direction) and the speed of the swipe operation (hereinafter, a swipe speed) (Step U21).

Next, the CPU 25 allows the scroll direction to have a predetermined angular range (for example, 30°) and determines whether or not there are any characteristic parts T which cut across the center of the display area when the momentum-scrolling is performed in any of scroll directions within the angular range (Step U22). At Steps U22 to U29 described below, the CPU 25 uses a characteristic point (for example, an inflection point) of a graph G as a characteristic part T. However, in addition to the characteristic point of the graph G, the origin may be used as a characteristic part T.

When determining that there are no characteristic parts T which cut across the center of the display area (Step U23; NO), the CPU 25 performs Steps U2 to U9 described above and then ends the swipe process.

On the other hand, when determining that there is at least one characteristic part T which cuts across the center of the display-area (Step U23; YES), the CPU 25 sets, as a target point, the position of a characteristic part T (characteristic point of the graph G in the modification) closest to the center of the display screen among the at least one characteristic part T, which is determined to cut across the center of the display area, among characteristic parts T of the coordinate system and the graph G and sets a direction from the target point toward the center of the display screen as the scroll direction (Step U24). Thus, the scroll direction is set in such a way that the characteristic part T moves to the center of the display area by the momentum-scrolling.

Next, the CPU 25 calculates the total movement amount (dX, dY) used to scroll the display range (Xmin, Xmax, Ymin, Ymax) so that the target point reaches the center of the display area and stores the calculated total movement amount (dX, dY) in the movement amount data storage area 244 (Step U25).

Next, the CPU 25 calculates the change amount (ΔX, ΔY) of the display range (Xmin, Xmax, Ymin, Ymax) per unit time from the calculated total movement amount (dX, dY) and the swipe speed and stores the calculated change amount (ΔX, ΔY) in the change amount data storage area 245 (Step U26).

Next, the CPU 25 changes the display range of the coordinate system according to the calculated change amount (ΔX, ΔY), stores the changed display range in the display range data storage area 242, sets the changed display range to the display 210 (resets the display range), calculates values of the function within the reset display range, and redraws the graph G of the function in the display area (Step U27). Thus, in response to the swipe operation, the graph G momentum-scrolls in the scroll direction.

Next, the CPU 25 determines whether or not the display range has momentum-scrolled by the total movement amount (dX, dY) stored in the movement amount data storage area 244, namely, whether or not the characteristic part T as the target point has moved to the center of the display area (Step U28). When determining that the display range has not momentum-scrolled by the total movement amount (dX, dY) yet (Step U28; NO), the CPU 25 returns to Step U27. When returning to Step U27, the CPU 25 may slow down the scroll speed by one level.

On the other hand, when determining that the display range has momentum-scrolled by the total movement amount (dX, dY) (Step U28; YES), the CPU 25 stops the momentum-scrolling (Step U29) and ends the swipe process. Thus, in the case of the momentum-scrolling, the momentum-scrolling stops at a time when the characteristic part T reaches the center of the display area.

### Action Example

Next, the action of the graph display apparatus 1A is described in detail with reference to the drawings.

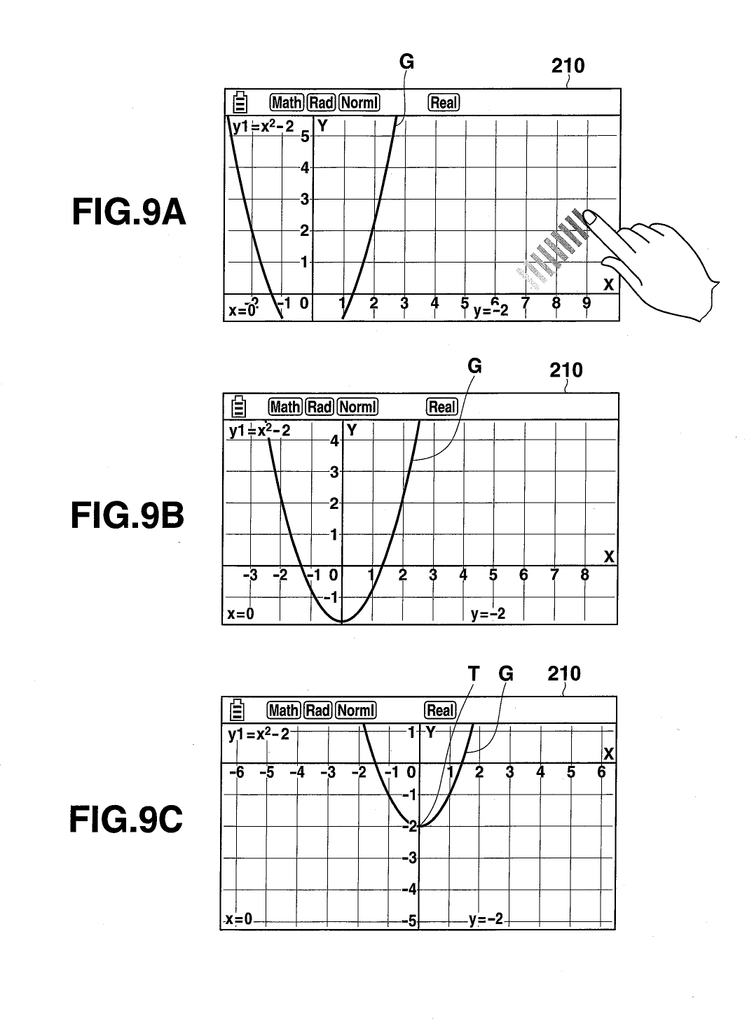

First, a user inputs a function “y=x²−2” (Step S1) and sets a display range of an XY coordinate system, “Xmin=−3, Xmax=10, Ymin=−1, Ymax=6”, to the display area of the display 210 (Step S2). Then, as shown in FIG. 9A, a graph G of the function “y=x²−2” within the display range is displayed (drawn) on the display 210 (Step S3).

Next, when the user performs a swipe operation in the upper-right direction (Step S11), the upper-right direction is calculated as the scroll direction, and the swipe speed is calculated (Step U21).

Next, it is determined that there is a characteristic part T (an inflection point of the graph G in this example) which cuts across the center of the display area when the momentum-scrolling is performed in any of scroll directions within a predetermined angular range (Step U23; YES), the position of the characteristic point T (inflection point of the graph G) is set as a target point, and a direction (upper-right direction in this example) from the target point toward the center of the display screen is set as the scroll direction (Step U24). Thus, the scroll direction is set in such a way that the characteristic part T (inflection point of the graph G) moves to the center of the display area by the momentum-scrolling.

Next, the total movement amount (dX, dY) used to scroll the display range (Xmin, Xmax, Ymin, Ymax) of the coordinate system so that the target point reaches the center of the display area is calculated (Step U25), and also the change amount (ΔX, ΔY) of the display range per unit time is calculated (Step U26).

Next, as shown in FIG. 9B, the display range of the coordinate system is reset according to the calculated change amount (ΔX, ΔY), values of the function “y=x²−2” within the reset display range are calculated, and the graph G of the function is redrawn in the display area (Step U27). By executing the contents of this step at unit time intervals, the display range of the coordinate system momentum-scrolls in the scroll direction.

When it is determined that the display range has momentum-scrolled by the total movement amount (dX, dY) (Step U28; YES), as shown in FIG. 9C, the momentum-scrolling of the display range of the coordinate system stops (Step U29). Thus, the momentum-scrolling stops at a time when the characteristic part T (inflection point of the graph G) reaches the center of the display area.

As described above, according to the modification, in addition to the effects obtained by the graph display apparatus 1 of the embodiment, as shown in FIGS. 8 (Step U22), 9A to 9C and the like, the scroll direction is set in such a way that a characteristic part T moves to the center of the display area by the momentum-scrolling. Hence, even if the scroll direction is not accurately set, the momentum-scrolling can be stopped at a proper position. Since it is unnecessary to set the scroll direction accurately, user's troublesomeness in momentum-scrolling the display range of the coordinate system can be further reduced.

It is needless to say that the detailed configuration and action of each component of the graph display apparatus 1 of the embodiment (or the graph display apparatus 1A of the modification) can be appropriately modified without departing from the scope of the present invention.

For example, the graph display apparatus of the present invention is applicable to electronic devices in general such as a scientific electronic calculator, an electronic dictionary, a mobile phone, a personal computer, a PDA (Personal Digital Assistant) and a game machine. Further, the graph display program 240 (or 240A) of the present invention may be stored in a memory card, a CD or the like attachable/detachable to/from the graph display apparatus 1 (or 1A).

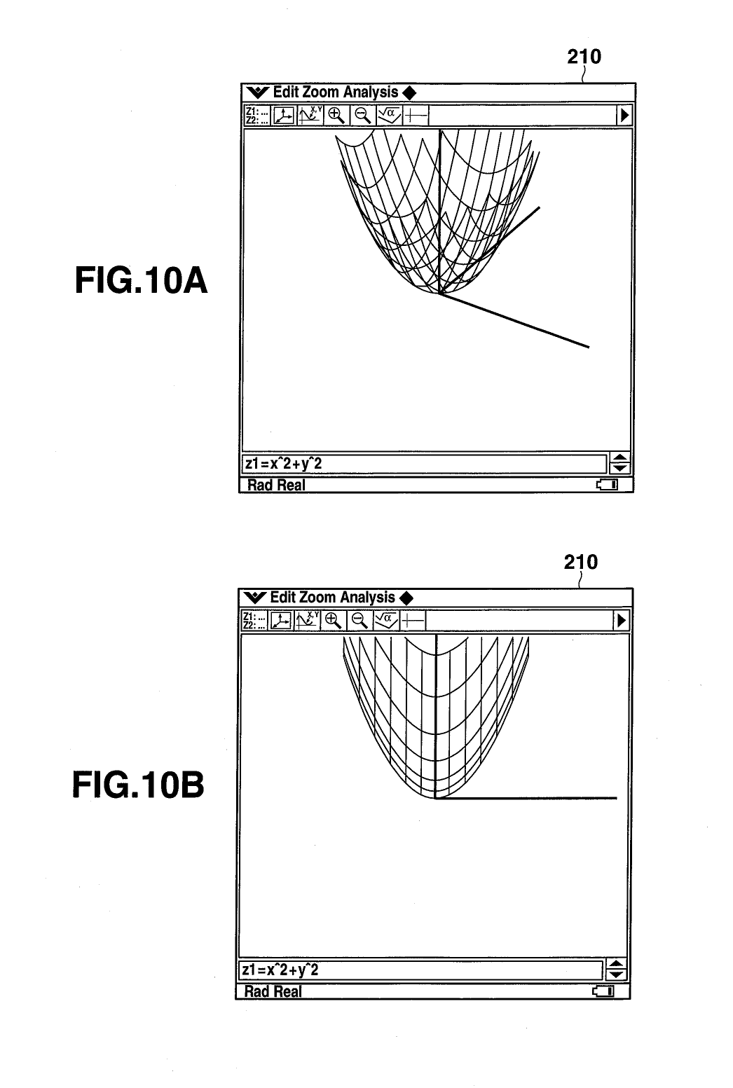

Further, in the above, the coordinate axes of the coordinate system are the X axis and the Y axis. However, coordinate axes of other names may be used. Further, in the above, the coordinate system is the cartesian coordinate system. However, another type of coordinate system such as an oblique coordinate system or a polar coordinate system may be used. Further, in the above, the coordinate system is two dimensional. However, as shown in FIG. 10A, the coordinate system may be three dimensional. In this case, as shown in FIGS. 10A and 10B, it is preferable that, in response to a swipe operation, the display content in the coordinate system automatically rotate on the origin with inertia, and the automatic rotation is stopped at a time when any of the coordinate axes matches the longitudinal direction (vertical direction) or the lateral direction (horizontal direction).

Further, in the swipe process described with reference to FIG. 4 or 8, the momentum-scrolling is stopped at a time when a characteristic part T reaches the center of the display area (at a time when the total movement amount of the momentum-scrolling is made). However, the momentum-scrolling may be stopped at a time when a characteristic part T reaches the center of the display area only when the speed of the momentum-scrolling at the time is equal to or less than a predetermined speed. In this case, by a user increasing the swipe speed, the momentum-scrolling can continue without stopping even when a characteristic part T reaches the center of the display area. Accordingly, a situation in which the momentum-scrolling automatically stops although a user does not expect it can be prevented from happening.

Further, in the above, the total movement amount is determined before the momentum-scrolling. However, it is possible that whether or not a characteristic part T reaches the center of the display area is determined while the display content is strolled, and the momentum-scrolling is stopped at a time when it is determined that the characteristic part T reaches the center thereof.

In the above, several embodiments or the like of the present invention are described. However, the scope of the present invention is not limited thereto and hence includes the scope of claims attached below and the scope of equivalents.

What is claimed is:

1. A graph display apparatus comprising:
a display device;
a graph display control unit which sets a coordinate system to a display area of the display device and displays a graph in the coordinate system;
a scroll direction setting unit which sets a scroll direction according to an operation performed by a user; and
a scroll control unit which makes the displayed graph momentum-scroll in the scroll direction and stops the momentum-scrolling at a time when a characteristic part of at least one of the coordinate system and the graph reaches a center of the display area in at least one of an X-direction and a Y-direction.

2. The graph display apparatus according to claim 1, wherein
the graph is a graph of a function, and
the characteristic part is at least one of a coordinate axis and a characteristic point of the graph.

3. The graph display apparatus according to claim 2, wherein the scroll direction setting unit sets the scroll direction in such a way that the characteristic part moves to the center of the display area by the momentum-scrolling.

4. The graph display apparatus according to claim 1 further comprising:
a touch panel integrated with a display of the display device; and
an enlargement/reduction unit which enlarges/reduces the displayed graph with a pinch-out/pinch-in operation performed by the user on the touch panel.

5. The graph display apparatus according to claim 1 further comprising a touch panel integrated with a display of the display device, wherein
the scroll control unit includes a scroll speed setting unit which sets a scroll speed according to a speed of a swipe operation performed by the user on the touch panel, and
when the scroll speed is equal to or less than a predetermined speed, the scroll control unit stops the momentum-scrolling at the time when the characteristic part reaches the center of the display area.

6. The graph display apparatus according to claim 1, wherein
the graph is a graph of a function, and
the scroll control unit changes a display range of the coordinate system, calculates a value of the function within the changed display range and draws the graph in the display area, thereby making the graph momentum-scroll.

7. A graph display method for a graph display apparatus including a display device, the graph display method comprising the steps of:
setting a coordinate system to a display area of the display device and displaying a graph in the coordinate system;
setting a scroll direction according to an operation performed by a user; and
controlling the displayed graph to momentum-scroll in the scroll direction and stopping the momentum-scrolling at a time when a characteristic part of at least one of the coordinate system and the graph reaches a center of the display area in at least one of an X-direction and a Y-direction.

8. The graph display method according to claim 7, wherein
the graph is a graph of a function, and
the characteristic part is at least one of a coordinate axis and a characteristic point of the graph.

9. The graph display method according to claim 8, wherein, in the scroll direction setting step, the scroll direction is set in such a way that the characteristic part moves to the center of the display area by the momentum-scrolling.

10. The graph display method according to claim 7, wherein
the display device includes a touch panel integrated with a display, and
the graph display method further comprises a step of enlarging/reducing the displayed graph with a pinch-out/pinch-in operation performed by the user on the touch panel.

11. The graph display method according to claim 7, wherein
the display device includes a touch panel integrated with a display,
the controlling step includes a step of setting a scroll speed according to a speed of a swipe operation performed by the user on the touch panel, and
when the scroll speed is equal to or less than a predetermined speed, the momentum-scrolling is stopped at the time when the characteristic part reaches the center of the display area in the controlling step.

12. The graph display method according to claim 7, wherein
the graph is a graph of a function, and
in the controlling step, a display range of the coordinate system is changed, a value of the function within the changed display range is calculated and the graph is drawn in the display area, whereby the graph is controlled to momentum-scroll.

13. A storage medium having stored thereon a graph display program for a computer including a display device, the graph display program causing the computer to function as:
a display device;
a graph display control unit which sets a coordinate system to a display area of the display device and displays a graph in the coordinate system;
a scroll direction setting unit which sets a scroll direction according to an operation performed by a user; and
a scroll control unit which makes the displayed graph momentum-scroll in the scroll direction and stops the momentum-scrolling at a time when a characteristic part of at least one of the coordinate system and the graph reaches a center of the display area in at least one of an X-direction and a Y-direction.

14. The storage medium according to claim 13, wherein
the graph is a graph of a function, and
the characteristic part is at least one of a coordinate axis and a characteristic point of the graph.

15. The storage medium according to claim 14, wherein the scroll direction setting unit sets the scroll direction in such a way that the characteristic part moves to the center of the display area by the momentum-scrolling.

16. The storage medium according to claim 13, wherein
the display device includes a touch panel integrated with a display, and
the program further causes the computer to function as an enlargement/reduction unit which enlarges/reduces the displayed graph with a pinch-out/pinch-in operation performed by the user on the touch panel.

17. The storage medium according to claim 13, wherein
the display device includes a touch panel integrated with a display,
the scroll control unit includes a scroll speed setting unit which sets a scroll speed according to a speed of a swipe operation performed by the user on the touch panel, and
when the scroll speed is equal to or less than a predetermined speed, the scroll control unit stops the momentum-scrolling at the time when the characteristic part reaches the center of the display area.

18. The storage medium according to claim 13, wherein
the graph is a graph of a function, and
the scroll control unit changes a display range of the coordinate system, calculates a value of the function within the changed display range and draws the graph in the display area, thereby making the graph momentum-scroll.
